(19) United States
(12) Patent Application Publication
(10) Pub. No.: US 2019/0123382 A1
(43) Pub. Date: Apr. 25, 2019

(54) NONAQUEOUS ELECTROLYTE SECONDARY BATTERY POROUS LAYER

(71) Applicant: Sumitomo Chemical Company, Limited, Toyota (JP)

(72) Inventor: Toshihiko OGATA, Osaka (JP)

(21) Appl. No.: 16/169,132

(22) Filed: Oct. 24, 2018

(30) Foreign Application Priority Data
Oct. 24, 2017 (JP) 2017-205595

(51) Int. Cl. H01M 10/058; H01M 4/62; H01M 2/16

(52) U.S. Cl. CPC H01M 10/058; H01M 4/621; H01M 2004/021; H01M 2/16; H01M 4/624

(57) ABSTRACT

The present invention provides a nonaqueous electrolyte secondary battery porous layer having excellent heat resistance. A nonaqueous electrolyte secondary battery porous layer (1) in accordance with an aspect of the present invention includes an aramid filler (11) having a branched structure.

This Nonprovisional application claims priority under 35 U.S.C. § 119 on Patent Application No. 2017-205595 filed in Japan on Oct. 24, 2017, the entire contents of which are hereby incorporated by reference.

### TECHNICAL FIELD

The present invention relates to a porous layer for a nonaqueous electrolyte secondary battery (hereinafter referred to as “nonaqueous electrolyte secondary battery porous layer”). The present invention also relates to (i) a separator for a nonaqueous electrolyte secondary battery (hereinafter referred to as a “nonaqueous electrolyte secondary battery separator”), which includes the porous layer, (ii) a member for a nonaqueous electrolyte secondary battery (hereinafter referred to as a “nonaqueous electrolyte secondary battery member”), which includes the porous layer, and (iii) a nonaqueous electrolyte secondary battery which includes the porous layer.

### BACKGROUND ART

Nonaqueous electrolyte secondary batteries (particularly lithium ion secondary batteries) have a high energy density and have therefore been in wide use as batteries for personal computers, mobile phones, portable information terminals, and the like. Such nonaqueous electrolyte secondary batteries have recently been developed as on-vehicle batteries.

Separators, which serve as members of nonaqueous electrolyte secondary batteries, have been likewise developed, and various kinds of separators have been proposed. For example, there are separators in each of which a porous layer containing an organic filler and an organic binder is disposed on a porous base material. For example, Patent Literature 1 discloses a laminated porous film including a polyolefin microporous film A and a porous layer B (including, as necessary constituent elements, a filler (a) (an absolute specific gravity falling within a certain range) and a binder resin (b)) which is provided on at least one surface of the polyolefin microporous film A. Patent Literature 1 further discloses that the filler (a) is preferably made of organic matters.

### CITATION LIST

### Patent Literature

[Patent Literature 1]

Pamphlet of International Publication No. WO2013/154090 (Publication Date: Oct. 17, 2013)

### SUMMARY OF INVENTION

### Technical Problem

However, such conventional techniques as one described above still has room for improvement in terms of heat resistance.

### Solution to Problem

The inventors of the present invention found that the above problem can be solved by causing a nonaqueous electrolyte secondary battery separator to include a porous layer which includes an aramid filler having a specific shape. The inventors of the present invention thus completed the present invention. Specifically, the present invention encompasses any of aspects described in the following <1> through <5>.

<1> A nonaqueous electrolyte secondary battery porous layer including: an aramid filler having a branched structure.

<2> The nonaqueous electrolyte secondary battery porous layer described in <1>, in which the aramid filler has an average roundness of not less than 0.05.

<3> A nonaqueous electrolyte secondary battery laminated separator including: a polyolefin porous film; and a nonaqueous electrolyte secondary battery porous layer described in <1> or <2>, the nonaqueous electrolyte secondary battery porous layer being disposed on at least one surface of the polyolefin porous film.

<4> A nonaqueous electrolyte secondary battery member including: a positive electrode, a nonaqueous electrolyte secondary battery porous layer described in <1> or <2> or a nonaqueous electrolyte secondary battery laminated separator described in <3>, and a negative electrode, the positive electrode, the nonaqueous electrolyte secondary battery porous layer or the nonaqueous electrolyte secondary battery laminated separator, and the negative electrode being arranged in this order.

<5> A nonaqueous electrolyte secondary battery including a nonaqueous electrolyte secondary battery porous layer described in <1> or <2> or a nonaqueous electrolyte secondary battery laminated separator described in <3>.

### Advantageous Effects of Invention

With an aspect of the present invention, it is possible to provide a nonaqueous electrolyte secondary battery porous layer having excellent heat resistance.

### BRIEF DESCRIPTION OF DRAWINGS

FIG. 1 is a microscopic image of a cross section of a porous layer in accordance with an embodiment of the present invention.

### DESCRIPTION OF EMBODIMENTS

The following description will discuss an embodiment of the present invention. The present invention is, however, not limited to such an embodiment. Further, the present invention is not limited to the description of the arrangements below, but may be altered in various ways by a skilled person within the scope of the claims. Any embodiment based on a proper combination of technical means disclosed in different embodiments is also encompassed in the technical scope of the present invention. Any numerical range expressed as “A to B” herein means “not less than A and not more than B” unless otherwise stated.

[1. Nonaqueous Electrolyte Secondary Battery Porous Layer]

A nonaqueous electrolyte secondary battery porous layer in accordance with an embodiment of the present invention (hereinafter also simply referred to as “porous layer”) includes an aramid filler having a branched structure. In other words, the porous layer in accordance with an embodiment of the present invention includes a particulate aramid resin having a branched structure.

<Porous Layer>

A “porous layer” herein has a structure in which many pores, connected to one another, are provided, so that the porous layer is a layer through which a gas or a liquid can pass from one surface to the other.

The porous layer has a thickness of preferably 0.5 μm to 15 μm and more preferably 2 μm to 10 μm. In a case where the porous layer has a thickness of not less than 0.5 μm, it is possible to (i) sufficiently prevent a short circuit from occurring in a battery and (ii) allow an amount of electrolyte retained in the porous layer to be maintained. Meanwhile, in a case where the porous layer has a thickness of not more than 15 μm, it is possible to (i) restrict an increase in resistance to ion permeation, (ii) prevent a positive electrode from deteriorating in a case where a charge-discharge cycle is repeated and (iii) prevent a rate characteristic and a cycle characteristic from deteriorating.

In addition, an increase in distance between the positive electrode and a negative electrode is restricted, so that the nonaqueous electrolyte secondary battery can be prevented from being large in size.

In view of adhesiveness of the porous layer to an electrode and ion permeability of the porous layer, a weight per unit area of the porous layer is, preferably 0.5 g/m² to 20 g/m², more preferably 0.5 g/m² to 10 g/m², and still more preferably 0.5 g/m² to 7 g/m², in terms of solid content.

<Aramid Filler>

An “aramid filler” herein means a filler containing an aramid resin as a main component. The expression “a filler contains an aramid resin as a main component” herein means that the aramid is contained in a percentage ratio of ordinarily not less than 50% by volume, preferably not less than 90% by volume, and more preferably not less than 95% by volume, relative to 100% by volume of the particles of the aramid.

The porous layer in accordance with an embodiment of the present invention contains an aramid filler in an amount of ordinarily not less than 50% by weight, preferably not less than 70% by weight, and more preferably not less than 90% by weight, relative to 100% by weight of a total weight of the porous layer.

The aramid filler in accordance with an embodiment of the present invention contains an aramid resin such as an aromatic polyamide or a wholly aromatic polyamide. Examples of the aramid resin encompass para-aramid and meta-aramid. Among these, para-aramid is preferable.

Examples of a method of preparing the para-aramid encompass, but are not particularly limited to, condensation polymerization of para-oriented aromatic diamine and para-oriented aromatic dicarboxylic acid halide. In such a case, para-aramid to be obtained is substantially made up of repeating units in which amide bonds are bonded at para positions or corresponding oriented positions (for example, oriented positions that extend coaxially or parallel in opposite directions such as the cases of 4,4′-biphenylene, 1,5-naphthalene, and 2,6-naphthalene) of aromatic rings. Examples of the para-aramid encompass para-aramids each having a para-oriented structure or a structure corresponding to a para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and paraphenylene terephthalamide/2,6-dichloroparaphenylene terephthalamide copolymer. Among these, poly(paraphenylene terephthalamide) is preferable.

A solution of the poly(paraphenylene terephthalamide) (hereinafter referred to as “PPTA”) can be prepared by a specific method. Examples of such a specific method encompass a method including the following steps (1) through (4).

(1) N-methyl-2-pyrrolidone (hereinafter also referred to as “NMP”) is introduced into a flask which is dried. Then, calcium chloride, which has been dried at 200° C. for 2 hours, is added. Then, the flask is heated to 100° C. to completely dissolve the calcium chloride.

(2) A temperature of the solution obtained in the step (1) is returned to room temperature, and then paraphenylenediamine (hereinafter abbreviated as “PPD”) is added. Then, the PPD is completely dissolved.

(3) While a temperature of the solution obtained in the step (2) is maintained at 20±2° C., terephthalic acid dichloride (hereinafter referred to as “TPC”) is added in ten separate portions at approximately 5-minute intervals.

(4) While a temperature of the solution obtained in the step (3) is maintained at 20±2° C., the solution is matured for 1 hour, and is then stirred under reduced pressure for 30 minutes to eliminate air bubbles, so that the solution of the PPTA is obtained.

The para-aramid can be a solution containing particles of PPTA. The solution can be prepared by a specific method. Examples of the specific method encompass a method in which the solution of the PPTA obtained in the steps (1) through (4) above is stirred at 300 rpm and at 40° C. for 1 hour so that the particles of the PPTA are deposited.

A method of preparing the meta-aramid is not limited to any particular one. Examples of the method encompass (1) condensation polymerization of (a) meta-oriented aromatic diamine and (b) meta-oriented aromatic dicarboxylic acid halide or para-oriented aromatic dicarboxylic acid halide and (2) condensation polymerization of (a) meta-oriented aromatic diamine or para-oriented aromatic diamine and (b) meta-oriented aromatic dicarboxylic acid halide. In such a case, the meta-aramid to be obtained includes a repeating unit in which amide bonds are bonded at meta positions or corresponding oriented positions of aromatic rings. Examples of the meta-aramid encompass poly(methaphenylene isophthalamide), poly(metabenzamide), poly(methaphenylene-4,4′-biphenylene dicarboxylic acid amide), poly(methaphenylene-2,6-naphthalene dicarboxylic acid amide), and a methaphenylene terephthalamide/2,6-dichloroparaphenylene terephthalamide copolymer.

The porous layer in accordance with an embodiment of the present invention can include a filler other than the aramid filler. Examples of the filler other than the aramid filler encompass an organic powder, an inorganic powder, and a mixture of an organic powder and an inorganic powder.

Examples of the organic powder encompass powders made of organic matter such as: (i) a homopolymer of a monomer such as styrene, vinyl ketone, acrylonitrile, methyl methacrylate, ethyl methacrylate, glycidyl methacrylate, glycidyl acrylate, or methyl acrylate or (ii) a copolymer of two or more of such monomers; fluorine-based resins such as polytetrafluoroethylene, ethylene tetrafluoride-propylene hexafluoride copolymer, ethylene tetrafluoride-ethylene copolymer, and polyvinylidene fluoride; melamine resin; urea resin; polyolefin; and polymethacrylate. The filler can be made of one of these organic powders, or can be made of two or more of these organic powders in combination. Among these organic powders, a polytetrafluoroethylene powder is preferable in view of chemical stability.

Examples of the inorganic powder encompass powders made of inorganic matters such as metal oxide, metal nitride, metal carbide, metal hydroxide, carbonate, and sulfate. Specific examples of the inorganic powder encompass powders made of inorganic matters such as alumina, boehmite, silica, titanium dioxide, aluminum hydroxide, and calcium carbonate. The filler can be made of one of these inorganic powders, or can be made of two or more of these inorganic powders in combination. Among these inorganic powders, an alumina powder is preferable in view of chemical stability.

<Shape of Aramid Filler>

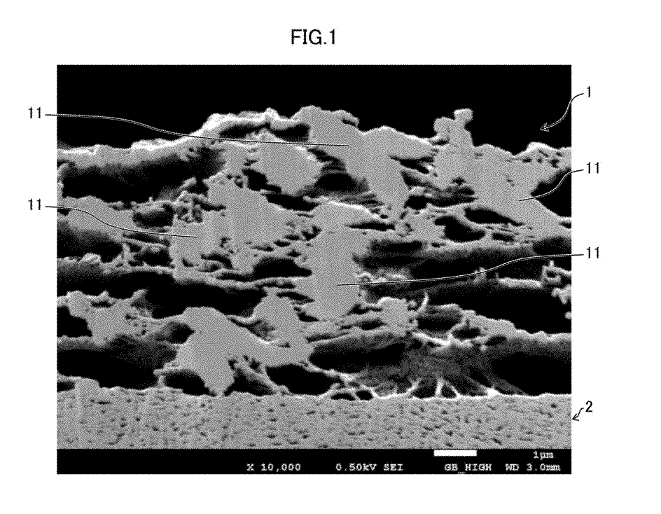

The porous layer in accordance with an embodiment of the present invention includes an aramid filler having a branched structure (see FIG. 1). Such an aramid filler has a larger spatial influence in comparison with a filler not having a branched structure. This brings about an effect of three-dimensionally inhibiting applied external force such as thermal shrinkage. As a result, a separator including the porous layer is resistant to deformation, so that thermal shrinkage is less likely to occur (i.e., the separator has a high dimensional retention). In addition, in the separator, matrix organization is developed in mesh-like form. This allows the separator to have a high two-dimensional retention. That is, the separator can have a high dimensional retention in any of (i) a direction (MD) in which the separator is transferred and (ii) a direction (TD) perpendicular to the MD (TD is hereinafter referred to as “widthwise (direction)”).

A widthwise dimensional retention can be calculated by, for example, a process described below. The MD dimensional retention can be likewise calculated.

(1) A test piece having a 5 cm×5 cm square shape is cut out from a laminated separator.

(2) At a center of the test piece, a 4 cm×4 cm square is drawn by marking lines.

(3) The test piece is sandwiched between 2 sheets of paper, and is held in an oven at 150° C. for 1 hour.

(4) The test piece is taken out of the oven, and dimensions of the marking lines of the square are measured. From the dimensions thus obtained, a dimensional retention is calculated according to the following formula:

Widthwise (TD) dimensional retention (%)=(W2/W1)×100 where (i) W1 is a widthwise (TD) length of a marking line before heating and (ii) W2 is a widthwise (TD) length of a marking line after heating.

The expression “a filler has a branched structure” herein means that recesses (also expressed as depression, concavity, and the like) and/or protrusions (also expressed as bumps, projections, and the like) are formed on surfaces of particles.

Representative examples of particles having a branched structure (shape) encompass irregularly-shaped particles (such as particles having dendrite shape, coral-like shape, and tufted shape). Representative examples of particles having a branched structure (shape) further encompass a shape made by bonding of individual particles (such as tetrapod-like shape and peanut-like shape). In contrast, particles having a spherical shape or a spindle-like shape ordinarily do not have a branched structure.

Whether or not particles have a branched structure can be determined three dimensionally (i.e., based on the shape of the particles as a whole) or can be determined by determined two dimensionally (i.e., in regard to a relationship between the particles and a certain flat surface). In a case where the presence/absence of the branched structure is determined two dimensionally, it is possible to use (i) a photograph of the aramid filler captured from a certain direction or (ii) a photograph of a cross-section of a porous layer which includes the aramid filler (see Examples for more details).

An average roundness of the aramid filler is preferably not less than 0.05, more preferably not less than 0.1, still more preferably not less than 0.2, further preferably not less than 0.3, still further preferably not less than 0.4, still yet further preferably not less than 0.5, and particularly preferably not less than 0.6. In a case where the average roundness is less than 0.05, a void between the particles of the aramid filler tends to be small. This may cause an increase in air permeability. Meanwhile, an upper limit value of the average roundness is preferably approximately 0.9. This is because the particles having an average roundness of not more than approximately 0.9 is highly likely to have a branched structure.

The average roundness of the aramid filler can be measured as follows.

(1) An image, in which a plurality of particles of an aramid filler are projected on a flat surface, is obtained. Such an image can be obtained by, for example, (i) photographing a plurality of particles of an aramid filler from one direction or (ii) photographing a cross section of a porous layer including a plurality of particles of an aramid filler.

(2) On the image obtained, respective roundness values of the particles of the aramid filler are measured. A roundness can be measured with use of any appropriate image analysis software (such as IMAGEJ).

(3) An average value of the roundness values is calculated, and is used as an average roundness.

Note that roundness is a value represented by “4π×(area)/(circumferential length²)”. The roundness having a value closer to 1 indicates a greater closeness to a perfect circle.

<Other Components>

The porous layer in accordance with an embodiment of the present invention can include a resin (hereinafter also referred to as “binder resin”) in addition to the aramid filler. The resin can serve as a binder resin to (i) bind particles of the aramid filler to each other, (ii) bind the aramid filler to an electrode, and (iii) bind the aramid filler to a porous film (porous base material).

The resin is preferably (i) insoluble in an electrolyte of a battery and (ii) electrochemically stable when the battery is in use. Examples of such a resin encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; a fluorine-containing rubber having a glass transition temperature of equal to or less than 23° C., among the fluorine-containing resins; a polyamide-based resin such as an aramid resin (aromatic polyamide and wholly aromatic polyamide); polyester-based resins such as aromatic polyester (e.g., polyarylate) and liquid crystal polyester; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, and polyether amide; and water-soluble polymers such as polyvinyl alcohol, polyethylene glycol, cellulose ether, sodium alginate, polyacrylic acid, polyacrylamide, and polymethacrylic acid.

Alternatively, a water-insoluble polymer can be suitably used as the resin contained in the porous layer. In producing the porous layer, a porous layer containing a water-insoluble polymer as a binder can be produced by using, as a coating solution, an emulsion obtained by dispersing the water-insoluble polymer (such as acrylate resin) in an aqueous solvent.

A “water-insoluble polymer” means a polymer that does not dissolve in an aqueous solvent but becomes particles so as to be dispersed in an aqueous solvent. The shape of the particles of the water-insoluble polymer is not limited to any particular one, but is preferably a spherical shape.

A “Water-insoluble polymer” herein means a polymer which has an insoluble content of not less than 90% by weight in a case where 0.5 g of the polymer is mixed with 100 g of water at 25° C. Meanwhile, the “water-soluble polymer” refers to a polymer which has an insoluble content of less than 0.5% by weight in a case where 0.5 g of the polymer is mixed with 100 g of water at 25° C.

The water-insoluble polymer is produced as polymer particles by, for example, polymerizing, in an aqueous solvent, a monomer composition containing a monomer.

The aqueous solvent for use in the polymerization of the water-insoluble polymer is not limited to any particular one, provided that (i) the aqueous solvent contains water and (ii) the water-insoluble polymer particles can be dispersed in the aqueous solvent. The aqueous solvent can contain an organic solvent (such as methanol, ethanol, isopropyl alcohol, acetone, tetrahydrofuran, acetonitrile, or N-methylpyrrolidone) which can be dissolved in water at any ratio to the water. The aqueous solvent can also contain (i) a surfactant such as sodium dodecylbenzene sulfonate, (ii) a dispersing agent such as a polyacrylic acid or a sodium salt of carboxymethyl cellulose, and/or (iii) the like.

Among the above resins, a polyolefin, a fluorine-containing resin, an aromatic polyamide, a water-soluble polymer, or the water-insoluble polymer in the form of particles dispersed in the aqueous solvent is more preferable. Among these resins, in a case where the porous layer is arranged so as to face a positive electrode, a fluorine-containing resin is still more preferable, and a polyvinylidene fluoride-based resin is particularly preferable. Examples of the polyvinylidene fluoride-based resin encompass: a homopolymer of vinylidene fluoride (that is, polyvinylidene fluoride); and a copolymer of vinylidene fluoride and at least one monomer selected from the group consisting of hexafluoropropylene, tetrafluoroethylene, trifluoroethylene, trichloroethylene, and vinyl fluoride is particularly preferable. This is because such a resin makes it easy to maintain various properties, such as a rate characteristic and a resistance characteristic (solution resistance), of a nonaqueous electrolyte secondary battery even in a case where the nonaqueous electrolyte secondary battery suffers acidic deterioration during operation of the nonaqueous electrolyte secondary battery.

Further, the water-soluble polymer or the water-insoluble polymer which is in the form of particles dispersed in the aqueous solvent is more preferable in view of a process and an environmental impact, because water can be used as a solvent to form the porous layer. The water-soluble polymer is still more preferably cellulose ether or sodium alginate, and particularly preferably cellulose ether.

Specific examples of the cellulose ether encompass carboxymethyl cellulose (CMC), hydroxyethyl cellulose (HEC), carboxyethyl cellulose, methyl cellulose, ethyl cellulose, cyanoethyl cellulose, and oxyethyl cellulose. The cellulose ether is more preferably CMC or HEC, and particularly preferably CMC. This is because CMC and HEC deteriorate less over an extended period of time of use and are excellent in chemical stability.

In view of adhesiveness of particles of an aramid filler, the water-insoluble polymer in the form of particles dispersed in the aqueous solvent is preferably a homopolymer of an acrylate monomer, such as methyl methacrylate, ethyl methacrylate, glycidyl methacrylate, glycidyl acrylate, methyl acrylate, ethyl acrylate, or butyl acrylate. Alternatively, the water-insoluble polymer is preferably a copolymer of two or more kinds of the monomers.

Note that the porous layer in accordance with an embodiment of the present invention can contain a single kind of resin or can contain a mixture of two or more kinds of resins.

A lower limit value of an amount of the resin contained in the porous layer in accordance with an embodiment of the present invention is preferably not less than 0.5% by weight, and more preferably not less than 1% by weight, relative to a total weight of the porous layer. Meanwhile, an upper limit value of the amount of the resin contained in the porous layer in accordance with an embodiment of the present invention is preferably not more than 99% by weight, and more preferably not more than 90% by weight. The amount of the resin contained is preferably not less than 0.5% by weight, in view of the fact that such a content improves adhesion of particles of an aramid filler, that is, in view of prevention of the aramid filler from falling off from the porous layer. The amount of the resin contained is preferably not more than 99% by weight, in view of a battery characteristic (particularly resistance to ion permeation) and heat resistance.

The porous layer in accordance with an embodiment of the present invention can further include another component other than the aramid filler and the resin. Examples of such another component encompass a surfactant and wax. Such another component is contained in an amount of preferably 0% by weight to 50% by weight, relative to a total weight of the porous layer.

<Method of Producing Porous Layer>

The porous layer can be produced by, for example, the following method. First, a solution, in which the above-described aramid is dissolved in a solvent, is obtained. Then, the solution is heated so that the aramid is deposited. This produces a suspension containing an aramid filler. The suspension can be used as a coating solution for the formation of the porous layer. Alternatively, a coating solution can be prepared by adding, to the suspension, (i) the above-described another component and (ii) a filler other than the aramid filler. Alternatively, it is possible to prepare a coating solution by (i) taking out the aramid filler by filtering the suspension containing the aramid filler and then (ii) dispersing the aramid filler in a dispersion medium such as water. Note that the aramid filler, which has been taken out, can easily be aggregated. When the aramid filler thus taken out is dispersed in the dispersion medium, therefore, it is preferable to crush the aramid filler which has been aggregated. Then, the porous layer can be formed by (i) coating a base material with the coating solution obtained as described above and then (ii) removing the solvent or the dispersion medium by drying or the like.

The shape of the aramid filler can be controlled by using the above-described method of producing the porous layer in accordance with an embodiment of the present invention. An example of a specific method of producing the porous layer will be described in Examples. Needless to say, however, such a specific method is not limited to the method described in Examples.

Examples of the base material encompass a polyolefin porous film and an electrode (described later). Examples of the solvent encompass N-methylpyrrolidone, N,N-dimethylacetamide, and N,N-dimethylformamide.

A method of coating the base material with the coating solution encompass publicly known coating methods such as that in which a knife, a blade, a bar, a gravure, or a die is used. A method of removing the solvent is a typical drying method. Examples of the drying method encompass natural drying, air-blowing drying, heat drying, and drying under reduced pressure. Note, however, that any method can be used, provided that the solvent can be sufficiently removed. In addition, a drying step can be carried out after the solvent or the dispersion medium contained in the coating solution is replaced with another solvent. Specific examples of the method, in which the solvent is replaced with another solvent and then the another solvent is removed, encompass a method in which (i) the solvent is replaced with a poor solvent having a low boiling point, such as water, alcohol, and acetone and (ii) the drying step is carried out.

[2. Nonaqueous Electrolyte Secondary Battery Laminated Separator] A laminated separator for a nonaqueous electrolyte secondary battery in accordance with an embodiment of the present invention (hereinafter referred to as a “nonaqueous electrolyte secondary battery laminated separator” or simply referred to as “laminated separator”) includes (i) a polyolefin porous film and (ii) the above-described porous layer disposed on at least one surface of the polyolefin porous film. The porous layer can be a layer which, serving as an outermost layer of the laminated separator, comes into contact with an electrode. The porous layer can be disposed on one surface or both surfaces of the polyolefin porous film.

<Polyolefin Porous Film>

The polyolefin porous film can serve as a base material of the laminated separator. The polyolefin porous film has therein many pores connected to one another, so that a gas or a liquid can pass through the polyolefin porous film from one surface to the other.

The “polyolefin porous film” means a porous film containing a polyolefin-based resin as a main component. The expression that a “porous film contains a polyolefin-based resin as a main component” means that the polyolefin-based resin accounts for not less than 50% by volume, preferably not less than 90% by volume, and more preferably not less than 95% by volume, of the entire material constituting the porous film.

Examples of the polyolefin-based resin encompass a homopolymer and a copolymer, any of which is obtained through (co)polymerization of a monomer such as ethylene, propylene, 1-butene, 4-methyl-1-pentene, and 1-hexene (which are thermoplastic resins). Examples of the homopolymer encompass polyethylene, polypropylene, and polybutene. Examples of the copolymer encompass an ethylene-propylene copolymer. Among these, polyethylene is preferable because it is capable of preventing (shutting down) a flow of an excessively large electric current at a lower temperature.

The polyolefin porous film has a thickness of preferably 4 μm to 40 μm and more preferably 5 μm to 20 μm. In a case where the polyolefin porous film has a thickness of not less than 4 μm, it is possible to sufficiently prevent a short circuit in a battery. Meanwhile, in a case where the polyolefin porous film has a thickness of not more than 40 μm, it is possible to (i) restrict an increase in resistance to ion permeation, (ii) prevent a positive electrode from deterioration which occurs due to repetitive charge-discharge cycles, and (iii) prevent a rate characteristic and a cycle characteristic from deterioration which occurs due to repetitive charge-discharge cycles. In addition, an increase in size of the nonaqueous electrolyte secondary battery, which occurs due to an increase in distance between the positive electrode and a negative electrode, can be prevented.

The polyolefin porous film has a porosity of preferably 20% by volume to 80% by volume and more preferably 30% by volume to 75% by volume. In a case where the porosity falls within these ranges, it is possible to (i) retain a larger amount of an electrolyte and (ii) reliably prevent (shut down) a flow of an excessively large electric current at a lower temperature. In a case where the porosity is not less than 20% by volume, it is possible to restrict resistance of the polyolefin porous film to ion permeation. The porosity is preferably not more than 80% by volume in view of mechanical strength of the polyolefin porous film.

<Method of Producing Polyolefin Porous Film>

A method of producing the polyolefin porous film can be, for example, a method in which (i) a pore forming agent is added to a polyolefin-based resin so as to form a film and then (ii) the pore forming agent is removed with use of an appropriate solvent.

Specifically, in a case where, for example, a polyolefin-based resin, which contains ultra-high molecular weight polyethylene and low molecular weight polyolefin which has a weight-average molecular weight of not more than 10,000, is used, it is preferable in view of production costs that the polyolefin porous film is produced by a method including: (1) kneading 100 parts by mass of ultra-high molecular weight polyethylene, 5 parts by mass to 200 parts by mass of low molecular weight polyolefin having a weight-average molecular weight of not more than 10,000, and 100 parts by mass to 400 parts by mass of a pore forming agent, so as to obtain a polyolefin resin composition; and

(2) forming the polyolefin resin composition into a rolled sheet by rolling,

(3) removing the pore forming agent from the rolled sheet obtained in the step (2);

(4) stretching the sheet obtained in the step (3), so as to obtain the polyolefin porous film.

Examples of the pore forming agent encompass an inorganic bulking agent and a plasticizer. Examples of the inorganic bulking agent encompass an inorganic filler.

Examples of the plasticizer encompass a low molecular weight hydrocarbon such as liquid paraffin.

<Method of Producing Nonaqueous Electrolyte Secondary Battery Laminated Separator>

A method of producing the nonaqueous electrolyte secondary battery laminated separator in accordance with an embodiment of the present invention can be, for example, the above-described method of producing the porous layer in which polyolefin porous film is used as a base material which is coated with the coating solution.

[3. Nonaqueous Electrolyte Secondary Battery Member, Nonaqueous Electrolyte Secondary Battery]

A nonaqueous electrolyte secondary battery member in accordance with an embodiment of the present invention includes a positive electrode, the above-described porous layer or the above-described laminated separator, and a negative electrode such that the positive electrode, the porous layer or the laminated separator, and the negative electrode are arranged in this order. A nonaqueous electrolyte secondary battery in accordance with an embodiment of the present invention includes the above-described porous layer or the above-described laminated separator. The nonaqueous electrolyte secondary battery typically has a structure in which the negative electrode and the positive electrode face each other through the porous layer or the laminated separator. The nonaqueous electrolyte secondary battery is configured so that a battery element is enclosed in an exterior member, the battery element including (i) the structure and (ii) an electrolyte with which the structure is impregnated. For example, the nonaqueous electrolyte secondary battery is a lithium ion secondary battery which achieves an electromotive force through doping with and dedoping of lithium ions.

<Positive Electrode>

Examples of the positive electrode encompass a positive electrode sheet having a structure in which an active material layer including a positive electrode active material and a binder resin is formed on a current collector. The active material layer can further include an electrically conductive agent.

The positive electrode active material is, for example, a material capable of being doped with and dedoped of lithium ions. Examples of such a material encompass a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound.

Examples of the binding agent encompass: thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, a thermoplastic polyimide, polyethylene, and polypropylene; acrylic resin; and styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

The positive electrode sheet can be produced by, for example, (I) a method in which pressure is applied to the positive electrode active material, the electrically conductive agent, and the binding agent on the positive electrode current collector to form a positive electrode mix thereon or (II) a method in which (i) an appropriate organic solvent is used so that the positive electrode active material, the electrically conductive agent, and the binding agent will be in a paste form to provide a positive electrode mix, (ii) the positive electrode mix is applied to the positive electrode current collector, (iii) the applied positive electrode mix is dried so that a sheet-shaped positive electrode mix is prepared, and then (iv) pressure is applied to the sheet-shaped positive electrode mix so that the sheet-shaped positive electrode mix is firmly fixed to the positive electrode current collector.

<Negative Electrode>

Examples of the negative electrode encompass a negative electrode sheet having a structure in which an active material layer including a negative electrode active material and a binder resin is formed on a current collector. The active material layer can further include an electrically conductive agent.

Examples of the negative electrode active material encompass (i) a material capable of being doped with and dedoped of lithium ions, (ii) a lithium metal, and (iii) a lithium alloy. Examples of the material encompass: carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode; metals such as aluminum (Al), lead (Pb), tin (Sn), bismuth (Bi), or silicon (Si), each of which is alloyed with alkali metal; cubic intermetallic compounds (AlSb, Mg₂Si, and NiSi₂) having lattice spaces in which alkali metals can be provided; and lithium nitrogen compounds (Li₃₋ₓMₓN (where M represents a transition metal)).

Examples of the negative electrode current collector encompass Cu, Ni, and stainless steel. Among these, Cu is preferable because it is not easily alloyed with lithium in the case of particularly a lithium-ion secondary battery and is easily processed into a thin film.

The negative electrode sheet can be produced, by, for example, (I) a method in which pressure is applied to the negative electrode active material on the negative electrode current collector to form a negative electrode mix thereon or (II) a method in which (i) an appropriate organic solvent is used so that the negative electrode active material will be in a paste form to provide a negative electrode mix, (ii) the negative electrode mix is applied to the negative electrode current collector, (iii) the applied negative electrode mix is dried so that a sheet-shaped negative electrode mix is prepared, and then (iv) pressure is applied to the sheet-shaped negative electrode mix so that the sheet-shaped negative electrode mix is firmly fixed to the negative electrode current collector. The above paste preferably includes the electrically conductive agent and the binding agent.

<Nonaqueous Electrolyte>

A nonaqueous electrolyte is, for example, a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Examples of the organic solvent encompass: carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into any of the organic solvents described above. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is still more preferably a mixed solvent of ethylene carbonate, dimethyl carbonate, and ethyl methyl carbonate. This is because such a mixed solvent leads to a wider operating temperature range, and is not easily decomposed even in a case where a negative electrode active material is a graphite material such as natural graphite or artificial graphite.

<Nonaqueous Electrolyte Secondary Battery Member Production Method and Nonaqueous Electrolyte Secondary Battery Production Method>

The nonaqueous electrolyte secondary battery member can be produced by, for example, arranging the positive electrode, the above-described porous layer or the above-described laminated separator, and the negative electrode in this order.

Alternatively, the nonaqueous electrolyte secondary battery can be produced by, for example, as follows. First, a nonaqueous electrolyte secondary battery member is placed in a container which serves as a housing of the nonaqueous electrolyte secondary battery. Then, the container is filled with a nonaqueous electrolyte. Then, while pressure inside the container is being reduced, the container is hermetically sealed. This produces the nonaqueous electrolyte secondary battery.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in more detail by Examples and Comparative Examples. Note, however, that the present invention is not limited to these Examples and Comparative Examples.

<Measuring Method and Evaluating Method>

In each of Examples below, physical properties of a laminated porous film (laminated separator) were measured and evaluated by a method described below.

(1) Confirmation of Branched Structure

A laminated porous film obtained in an Example was processed by an ion milling method with use of a cross section polisher (CP). This produced a flat cross section, which was then observed with use of a field emission scanning electrode microscope JSM-7600F (manufactured by JEOL Ltd.), so that an electron microscopic image at a magnification of 10,000 times was obtained. In this observation, an acceleration voltage was 0.5 kV. SEM surface observation was performed with use of a reflection electron image. The electron microscopic image thus obtained from the laminated porous film prepared in Example 1 is shown in FIG. 1.

(2) Measurement of Roundness of Aramid Filler

A solution, which contained an aramid filler obtained in Production Example, was dried on a glass plate. Then, the glass plate was observed with use of a field emission scanning electrode microscope JSM-7600F (manufactured by JEOL Ltd.), so that an electron microscopic image at a magnification of 10,000 times was obtained. In this observation, an acceleration voltage was 0.5 kV. SEM surface observation was performed with use of a reflection electron image.

An SEM image obtained was imported into a computer. With use of IMAGEJ (free software for image analysis, distributed by National Institutes of Health (NIH)), individual particles of an aramid filler were separated and detected with a certain luminance serving as a threshold. For the purpose of calculating an area of each particle of the aramid filler, a luminance of a part of a region of each particle of the aramid filler detected was increased if the luminance was low. A roundness of each detected particle of the aramid filler (111 particles in Example 1, and 139 particles in Example 2) was calculated. Then, an average of the roundness values calculated was used as an average roundness of the aramid filler.

Note that roundness is a value represented by “4π×(area)/(circumferential length²)”. The roundness having a value closer to 1 indicates a greater closeness to a perfect circle.

(3) Dimensional Retention (Heat Resistance)

A dimensional retention was measured with a heat resistance serving as an index. First, a test piece having a 5 cm×5 cm square shape was cut out from a laminated porous film. At a center of the test piece, a 4 cm×4 cm square was drawn by marking lines. This test piece was sandwiched between 2 sheets of paper, and was held in an oven at 150° C. for 1 hour. Then, the test piece was taken out of the oven, and dimensions of the marking lines of the square were measured. From the dimensions thus obtained, a dimensional retention was calculated. A method of calculating the dimensional retention is as follows. Widthwise (TD) dimensional retention (%)=(W2/W1)×100 where (i) W1 is a widthwise (TD) length of a marking line before heating and (ii) W2 is a widthwise (TD) length of a marking line after heating.

(4) Air Permeability as Measured Through Gurley Method (Sec/100 cc)

In conformity with a JIS P 8117, air permeability of the laminated porous film was measured with the use of a digital timer Gurley densometer manufactured by YASUDA SEIKI SEISAKUSHO, LTD.

<Aramid Filler Production Example>

(Aramid Polymerization Solution)

Poly(paraphenylene terephthalamide) was produced with use of a 500-mL separable flask having a stirring blade, a thermometer, a nitrogen incurrent canal, and a powder addition port. Specifically, 440 g of N-methyl-2-pyrrolidone (NMP) was introduced in the flask which had been sufficiently dried. Then, 30.2 g of calcium chloride powder, which had been vacuum-dried at 200° C. for 2 hours, was added. Then, the temperature was raised to 100° C. so that the calcium chloride powder was completely dissolved. The temperature of the resultant solution was returned to room temperature, and then 13.2 g of paraphenylenediamine was added. Then, the paraphenylenediamine was completely dissolved. While the temperature of the resultant solution was maintained at 20° C.±2° C., 23.47 g of terephthalic acid dichloride was added in 4 separate portions at intervals of approximately 10 minutes. Then, while the resultant solution was being stirred at 150 rpm and maintained at 20° C.±2° C., the solution was matured for 1 hour. This produced an aramid polymerization solution.

(Method of Preparing Solution Containing Aramid Filler)

The aramid polymerization solution obtained was stirred at 40° C. at 300 rpm for 1 hour so that poly(paraphenylene terephthalamide) was deposited. This produced a solution containing an aramid filler.

### Example 1

The solution containing the aramid filler, which was obtained in the production example, was used as a coating solution. A porous film made of polyethylene (having a thickness of 12 μm and a porosity of 41%) was coated with the coating solution by a doctor blade method. A laminated body, which was the resultant coated product, was rested in air at a temperature of 50° C. and at a relative humidity of 70% for 1 minute. Then, the laminated body was cleaned by being in immersed in ion exchange water. Then, the resultant product was dried in an oven at 70° C. This produced a laminated porous film (1) including a porous layer and the porous film made of polyethylene, the porous layer and the porous film being disposed on each other. A weight per unit area of the porous layer in the laminated porous film (1) was 3.0 g/m². The results of evaluation of the laminated porous film (1) are shown in Table 1.

### Example 2

A coating solution was changed from that used in Example 1 to another one. Specifically, a coating solution was prepared by adding Alumina C (manufactured by Nippon Aerosil Co., Ltd.) and NMP to the solution containing the aramid filler, which was obtained in the production example. A weight ratio between poly(paraphenylene terephthalamide) and Alumina C in the coating solution was 1:1. In addition, an amount of NMP added was set so that a solid content (a ratio of the weights of the poly(paraphenylene terephthalamide) and the Alumina C to the weight of the coating solution) would account for 3% by weight. Other than the above conditions for the coating solution, a laminated porous film (2) was obtained as in Example 1. A weight per unit area of the porous layer in the laminated porous film (2) was 1.8 g/m². Physical properties of the laminated porous film (2) are shown in Table 1.

### Comparative Example 1

A coating solution was changed from that used in Example 1 to another one. Specifically, the aramid polymerization solution obtained in the production example was used as a coating solution. In other words, a liquid containing no aramid filler was used as coating solution. Other than the above conditions for the coating solution, a laminated porous film (3) was obtained as in Example 1. A weight per unit area of the porous layer in the laminated porous film (3) was 1.9 g/m². Physical properties of the laminated porous film (3) are shown in Table 1.

TABLE 1

| | | | Dimensional | Air |
|---|---|---|---|---|
| | Branched | | retention | permeability |
| | structure | Roundness | (%) | (sec/100 cc) |
| Example 1 | Yes | 0.7 | 73 | 241 |
| Example 2 | Yes | 0.8 | 95 | 247 |
| Comparative | No | N/A | 95 | 692 |
| Example 1 | | | | |

(Results)

FIG. 1 shows the porous layer 1 disposed on the porous film 2 prepared in Example 1. A plurality of particles of aramid filler 11 were observed in the porous layer 1. As is evident from FIG. 1, the aramid filler 11 contained in the porous layer 1 had a branched structure. Likewise, the porous layer prepared in Example 2 contained an aramid filler made up of a plurality of particles, that is, the aramid filler had a branched structure.

Meanwhile, the porous layer prepared in Comparative Example 1 contained no aramid filler. In other words, the aramid resin in the porous layer did not have a form of particles. There was therefore no branched structure of an aramid filler.

In addition, as shown in Table 1, the laminated porous film (1) and the laminated porous film (2) each exhibited high levels of dimensional retention and air permeability. Meanwhile, the laminated porous film (3), which did not have a branched structure (i.e., which contained no aramid filler), exhibited high air permeability. This indicates decreased ion permeability.

### INDUSTRIAL APPLICABILITY

The present invention can be used for, for example, production of a nonaqueous electrolyte secondary battery.

### REFERENCE SIGNS LIST

1 Nonaqueous electrolyte secondary battery porous layer
11 Aramid filler

1. A nonaqueous electrolyte secondary battery porous layer comprising:
an aramid filler having a branched structure.

2. The nonaqueous electrolyte secondary battery porous layer as set forth in claim 1, wherein
the aramid filler has an average roundness of not less than 0.05.

3. A nonaqueous electrolyte secondary battery laminated separator comprising:
a polyolefin porous film; and
a nonaqueous electrolyte secondary battery porous layer recited in claim 1, the nonaqueous electrolyte secondary battery porous layer being disposed on at least one surface of the polyolefin porous film.

4. A nonaqueous electrolyte secondary battery member comprising:
a positive electrode;
a nonaqueous electrolyte secondary battery porous layer recited in claim 1; and
a negative electrode,
the positive electrode, the nonaqueous electrolyte secondary battery porous layer, and the negative electrode being arranged in this order.

5. A nonaqueous electrolyte secondary battery comprising:
a nonaqueous electrolyte secondary battery porous layer recited in claim 1.

6. A nonaqueous electrolyte secondary battery member comprising:
a positive electrode;
a nonaqueous electrolyte secondary battery laminated separator recited in claim 3; and
a negative electrode,
the positive electrode, the nonaqueous electrolyte secondary battery laminated separator, and the negative electrode being arranged in this order.

7. A nonaqueous electrolyte secondary battery comprising:
a nonaqueous electrolyte secondary battery laminated separator recited in claim 3.
